(19) United States
(12) Patent Application Publication
(10) Pub. No.: US 2014/0200956 A1
(43) Pub. Date: Jul. 17, 2014

(54) SYSTEMS AND METHODS OF GATHERING CONSUMER INFORMATION

(71) Applicant: Eminvent, LLC, New York, NY (US)

(72) Inventor: Seth Gerszberg, New York, NY (US)

(73) Assignee: EMINVENT, LLC, New York, NY (US)

(21) Appl. No.: 14/136,424

(22) Filed: Dec. 20, 2013

Related U.S. Application Data
(60) Provisional application No. 61/753,406, filed on Jan. 16, 2013.

(51) Int. Cl. G06Q 30/02

(52) U.S. Cl. CPC G06Q 30/0201
USPC 705/7.29

(57) ABSTRACT

A computer-implemented method for collecting consumer information, including receiving a plurality of images of consumers; identifying at plurality of consumer characteristics from the images of consumers; and storing the identified characteristics in a consumer information database. Consumer characteristics include consumer age, race, weight, height, information regarding clothing worn by consumer (brand, style, type, color, etc.), body temperature, amount of time spent in a location, travel path through a location, time spent in proximity to a particular product, and/or identification of a product considered but not purchased. The method may include receiving information from a point of sale device and storing the received information and/or generating an advertisement, an alert regarding a consumer travel pattern within a location, a list of products that share one or more consumer characteristics, and/or at least one of a survey and coupon for a product not purchased.

### CROSS-REFERENCE TO RELATED APPLICATION

This application is related to and claims priority to U.S. Provisional Patent Application Ser. No. 61/753,406, filed Jan. 16, 2013, entitled System and Method of Gathering Consumer Information, the entirety of which is incorporated herein by reference.

### STATEMENT REGARDING FEDERALLY SPONSORED RESEARCH OR DEVELOPMENT

n/a

### FIELD OF THE INVENTION

The present invention provides systems and methods for capturing data related to consumer behavior and information and the analysis and utilization thereof.

### BACKGROUND OF THE INVENTION

Many companies collect consumer information in an attempt to use such information to predict consumer purchasing behavior. Such predictability is important to merchants because it enables merchants to improve the stocking of their inventory, plan better locations for their stores, and more effectively advertise and market their goods and services. Companies able to effectively collect and synthesize the highest amount and quality of consumer information will likely be the company best able to predict consumer behavior and thus generate the most sales.

However, despite the advent of e-commerce and other electronic shopping and sales mechanisms, it is typically still difficult for companies to accumulate, process and analyze information to accurately predict a consumer's purchasing behavior. Two main types of information used for this purpose include personal information and demographic information. Personal information includes the name, address and telephone number of a particular customer, and perhaps his or her social security number. Demographic information may contain a customer's county of residence, income range, the highest level of education achieved, and similar non-personal identifying consumer information. While such information may provide some indication of a consumer's ability or likelihood of making a purchase in a selected geographic area, this general personal and demographic info may be less likely to indicate whether a consumer will purchase a specific product or what, if any, other purchasing or behavioral tendencies the consumer may have.

Accordingly, it would be beneficial to provide improved systems and methodologies for capturing and analyzing information related to consumer behavior and purchasing tendencies.

### SUMMARY OF THE INVENTION

The present invention advantageously provides improved systems and methodologies for capturing and analyzing information related to consumer behavior and purchasing tendencies. For example, a system for compiling consumer information is provided, including an image database containing a plurality of images of consumers; an image analysis module configured to identify one or more consumer characteristics from the images in the image database; and a consumer characteristics database storing the identified consumer characteristics from the image analysis module. The system may include an image capture device in communication with the image database. The image analysis module may include a computer readable media storing computer-useable instructions and/or a central processing unit. The consumer characteristics may include at least one of consumer age, race, weight, and height, an article of clothing worn by the consumer, body temperature, amount of time spent in a location, travel path through a location or store departments visited within a location, time spent in proximity to a particular product, and/or the identification of a product considered but not purchased. The consumer characteristics database may receive and store information from a point of sale device, and may also send information to a point of sale device.

A computer-implemented method for collecting consumer information is also provided, including receiving a plurality of images of consumers; identifying at plurality of consumer characteristics from the images of consumers; and storing the identified characteristics in a consumer information database on a computer-readable storage device. The method may include capturing the plurality of images of consumers from an image capture device. The consumer characteristics may include at least one of consumer age, race, weight, and height, an article of clothing worn by the consumer, body temperature, amount of time spent in a location, travel path through a location, time spent in proximity to a particular product, and/or the identification of a product considered but not purchased. The method may include receiving information from a point of sale device and storing the received information in the consumer information database. The method may include generating a subset of the plurality of images of consumers in response to a query of one or more of the identified characteristics. The method may include generating an advertisement based on the information in the customer information database, generating an alert regarding a consumer travel pattern within a location based on the information in the customer information database, generating a list of products that share one or more consumer characteristics based on the information in the customer information database, and/or generating at least one of a survey and coupon for a product not purchased based on the information in the customer information database.

A computer program product for capturing and assessing consumer information is provided, including: a computer readable storage device; first program instructions to receive one or more images of consumers captured from an image capture device; second program instructions to identify a plurality of consumer characteristics from the images of consumers, which may include an article of clothing worn by the consumer; and third program instructions to compile the identified plurality of consumer characteristics in a consumer information database. The computer program product may include program instructions to generate a subset of the plurality of images of consumers in response to a query of one or more of the identified characteristics and/or instructions to receive information from a point of sale device and to store the received information in the consumer information database. The computer program product may include program instructions to generate an advertisement based on the information in the customer information database, generate an alert regarding a consumer travel pattern within a location based on the information in the customer information database, generate a list of products that share one or more consumer characteristics based on the information in the customer information database, and/or generate at least one of a survey and coupon for a product not purchased based on the information in the customer information database.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is an illustration of an example of a consumer information capture system in accordance with the principles of the present disclosure; and

FIG. 2 is a flow chart illustrating an example of a computer-implemented method for capturing, analyzing, and utilizing consumer information in accordance with the principles of the present disclosure.

### DETAILED DESCRIPTION OF THE INVENTION

The present disclosure relates to systems and methods for obtaining and/or utilizing consumer information. More specifically, the present disclosure provides a system including an image capture device that is constructed and arranged to capture a particular consumer in a setting where the consumer is either contemplating or completing purchase of goods or services. The system may store one or more recorded criteria related to 1) the consumer (such as one or more physical characteristics and/or audio recordings of the consumer), 2) the goods or services purchased, 3) goods or services considered but not purchased, and/or 4) behavior of the consumer during the contemplation or purchase sequence (e.g., time duration from initial consideration to completed sale, requests for assistance in making selection, etc.). The system may further include one or more hardware and/or software components to allow the recorded information to be stored, sorted, accessed, and utilized in a myriad of different ways as described further herein.

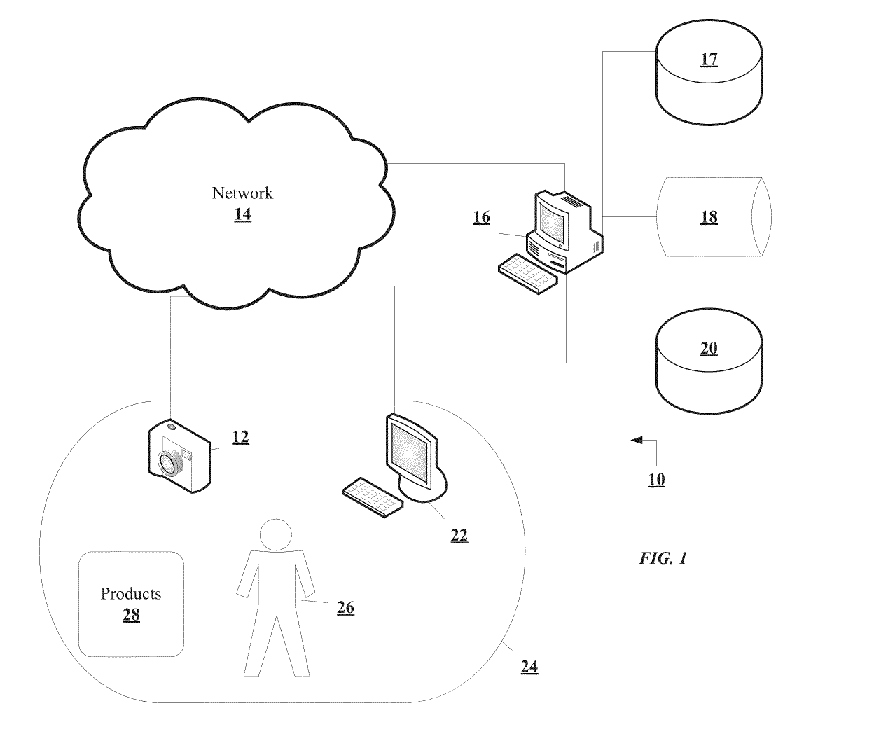

For example, and now referring to FIG. 1, a consumer information capture and utilization system 10 is shown. The system 10 may generally include one or more image capture devices 12 in communication with a communications network 14, and a computer and/or server 16 in communication with the network 14. An image database 17, an analysis module or engine 18, and a consumer information database 20 may reside on or otherwise be stored in the server 16. The system 10 may also include a point of sale device 22 which is located in or in proximity to a place of commerce 24, such as a retail store, kiosk, or other location where products and/or services are offered for sale. The image capture device(s) 12 may also be located in or about the place of commerce 24 to capture images of consumers 26 and/or products 28 offered for sale. As used herein, consumer is not limited to a retail consumer, but is broadly understood to mean any person, persons, or entity, engaged in a purchase or pre-purchase activity.

The image capture device 12 may include any type of device that is capable of capturing at least one identifiable characteristic of a consumer. For example, image capture devices of the present disclosure may include, but are not limited to, cameras for still photographs, cameras for video recording, cameras that simultaneously capture still and video, infrared recording devices, near infrared recording devices, thermal imaging devices, and combinations thereof and the like.

The image capture device 12 may be operatively associated with a controller that is selectively programmable to capture consumer information and activities. For example, such consumer information may include age, race, weight, gender, height, appearance, information related to clothing and/or accessories worn by consumers (such as garment or article of clothing type, style, brand, color, or the like), body temperature, time in store, travel path through store and/or store departments visited within a store location, product displays garnering the most consumer traffic or time spent within a store, proximity to one or more goods, time spent in proximity to particular goods, goods considered but not purchased, goods purchased, and/or form of payment. Such information may be identified from captured images as consumers traverse the place of commerce 24 and select, examine, and/or purchase goods and/or services. For example, the controller may be a computer based controller residing or accessible through the server 16 and having a graphical user interface whereby an operator of the system is able to access the controller for the image capture device and set parameters for the use of the image capture device. Parameters could include such aspects as a user buying a specified product, a user approaching a particular retail display in the store, a user either exiting a retail establishment after a purchase or returning to continue to shop after making a purchase, and/or combinations thereof.

The image capture device 12 may be coupled to or otherwise in communication with the network 14. The network 14 is configured to facilitate communication between the image capture device 12 and the server 16. The network 14 may be a communication network, such as a wireless network, local area network, wired network, or the Internet.

The server 16 may be configured to both send and receive information to and from the image capture device 12. For example, as described above, the server 16 may include an operator interface to control various aspects of the operation of the image capture device, including when, where, what and for how long the image capture device should capture images. The server 16 also receives the captured images from the image capture device 12, and the captured images are stored in the image database 17, and communicated to the image analysis module 18 for analysis and identification of one or more characteristics of consumers and their behavior or activities during a consumer's visit or stay in the place of commerce 24. For example, image analysis module 18 may be configured and arranged to be operatively associated with one or more programs or automated, computer-implemented instructions that discern consumers' physical characteristics and other information related to their behavior or activities within the place of commerce 24.

The consumer information database 20 stores or otherwise contains the information extracted or identified from the captured images by the image analysis module 18. The consumer information database may be operatively associated with a computer readable medium and/or constructed and arranged such that information received from the image analysis module 18 and/or the image capture devices 12 is selectively storable and sortable by particularized selectable parameters. Such user selected criteria can be any criteria or characteristic described herein, and may further include characteristics of the image capture activities, including but not limited to particularized time and location of the images captured by the image capture devices 12. As a non-limiting example, a user may access the system of the present invention and query a particular number of image capture devices based on the time that particular images were captured. For example, how many purchases occurred between 10:00 am and 2:00 pm that have information retrievable from the selected image capture devices. The system and method of the present invention provides for the compiling and output/export of user sortable information such that the output is instrumental in analyzing consumer behavior, as further described herein.

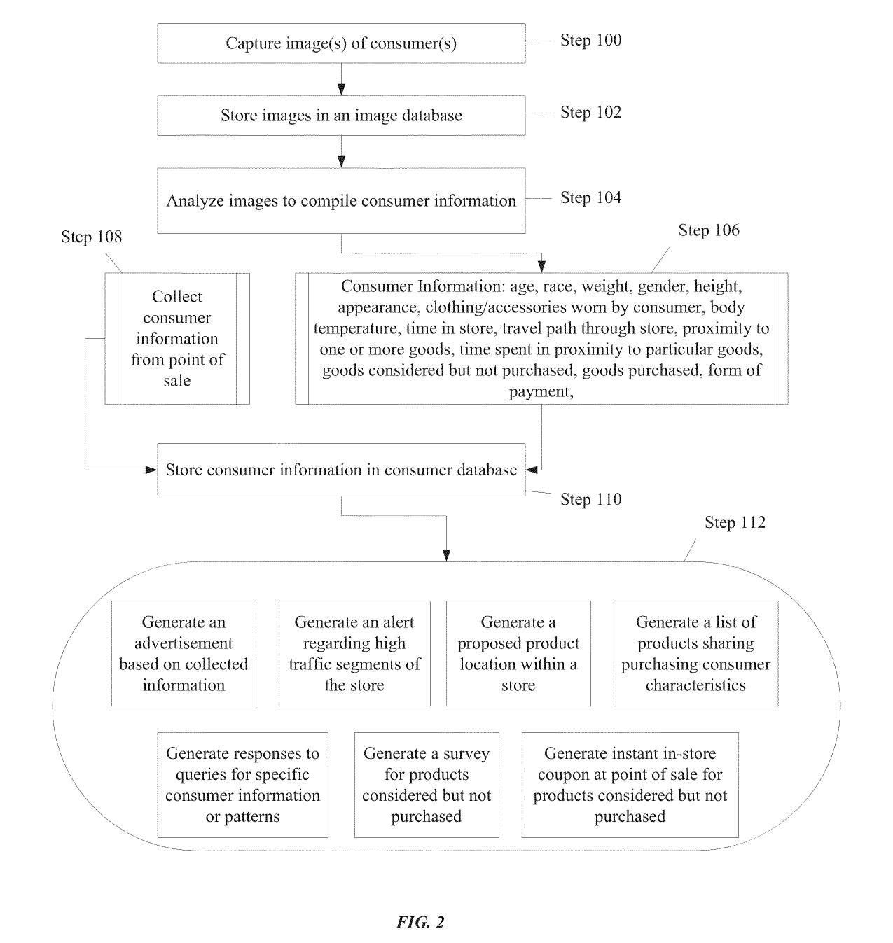

Now referring to FIG. 2, an exemplary method of collecting and utilizing consumer information is shown. The methods described herein may be computer-implemented and include one or more program instructions stored on computer-readable storage that are executable by one or more processing units and/or other hardware and software combinations. Primarily, one or more images of consumers may be captured by the image capture device(s) 12, for example (Step 100). The image capturing may be actuated by one or more predetermined events. For example, images may be captured when a consumer enters the place of commerce 24, approaches one or more products 28 and/or advertising displays, approaches a fitting room, approaches a cashier to purchase a product, or the like. The captured images may then be communicated to image database 17, which may reside on or be accessible through the server 16 (Step 102). The image database may also contain information regarding the image itself and/or information regarding its capture, such as time of image capture, location of image capture, image size, or the like.

The stored images may subsequently be analyzed to identify one or more characteristics of the consumer and/or the consumers activities or behavior, and may be performed by the image analysis module 18, for example (Step 104). Such consumer information or characteristics may include age, race, weight, gender, height, appearance, related to clothing and/or accessories worn by consumers (such as garment or article of clothing type, style, brand, color, or the like), body temperature, time in store, travel path through the store or place of commerce, proximity to one or more goods, time spent in proximity to particular goods, goods considered but not purchased, goods purchased, and/or form of payment (Step 106). The information attained through the analysis of the images may be collated with information received from a point of sale device 22, such as a cash register, credit card terminal, kiosk, or the like (Step 108). All of the information may then be stored in the consumer information database 20 (Step 110) for further analysis, sorting, and/or utilization for further commercial decision making and/or strategy related to marketing, product placement, inventory, and/or product pricing for example (Step 112).

Particular examples of analysis and utilization of the consumer information may include generating an advertisement based at least in part on the collected information. For example, advertising content, genre, and/or products may be selected for inclusion into an advertising campaign to specifically target consumers having characteristics ‘A,’ ‘B,’ and ‘C,’ who also previously purchased products ‘X’ and ‘Y.’

Another example of analyzing and utilizing the consumer information may include generating an alert to indicate higher traffic segments of the place of commerce and/or generating a proposed product placement or location within the place of commerce. For example, there may be multiple entrances and exits within a particular place of commerce, with numerous displays located throughout the location. A volume of consumer traffic through certain paths in the location may be tracked and analyzed to determine the most likely route of travel for most consumers generally, or consumers having particular characteristics. Products or services offered for sale may then be positioned along the particular path of travel to maximize the commercial opportunity for the seller. For example, products with the highest profit margin may be placed along the indicated busiest path of travel, or products that have been mostly purchased by consumers having particular characteristics may be placed along a path of travel indicated as traveled by consumers having those particular characteristics.

Another example of analyzing and utilizing the consumer information may include generating a list of a plurality of products that share common purchasing consumer characteristics. For example, if it is found that consumers having characteristics ‘A,’ ‘B,’ and ‘C’ routinely purchased both products ‘X’ and ‘Y,’ then a seller can strategically locate these items in proximity to each other to maximize the commercial opportunity of selling the inventory of products ‘X’ and ‘Y’. Alternatively, a list of products that were viewed, considered, tried on, or otherwise handled but not purchased by a consumer who did purchase product ‘X’ may be generated to aid a seller inventory, advertising, and/or product placement decisions.

Yet another example of analyzing and utilizing the consumer information may include generating responses to queries for specific consumer information or patterns. For example, an image or information subset may be generated for all consumers that purchased product ‘X.’ As another example, images of consumers and/or a consumer information subset may be generated for all consumers making purchases between 10:00 am and 11:15 am. Alternatively, an image subset or consumer information subset may be generated for every consumer who purchased products ‘X’ and ‘Y’ that paid using cash between the dates of August 1st and August 15^{th}. Another example may include generating a subset of the images on the image database or a subset from the consumer information database of consumers who wore purple shoes by brand ‘A’ and blue jeans to the place of commerce and purchased product ‘X.’ Another example may include generating an image or information subset of all consumers who wore hats in the place of commerce to identify what goods were purchased by such consumers. Additional search and/or subset criteria using the identified characteristics may be combined in virtually any number of possibilities to generate an image and/or consumer information subset of the available images and data, and are contemplated herein.

Still another example of analyzing and utilizing the consumer information may include generating a survey or questionnaire for products that were inspected, handled, or otherwise considered by a consumer but not purchased and/or generating a coupon or discounted purchase opportunity for products that were inspected, handled, or otherwise considered by a consumer but not purchased. For example, if images of consumer ‘A’ show that she handled product ‘X’ while in the place of commerce, but purchased product ‘Y’ instead, a coupon could be generated, at the pint of sale for example, offering a discounted purchase price for product ‘X’ if purchased right away. In addition, and/or alternatively to offering a coupon, a survey or questionnaire may be presented at the point of sale and/or subsequently to the consumer using information collected from the sale of product ‘Y’ (e.g., mailing address, email address, phone number, etc.) inquiring as to why product ‘X’ wasn't purchased.

In another example, the image capture device may be constructed and arranged with infrared (IR) or near infrared (NIR) information gathering capabilities and can record information relating to a consumer's body temperature. Such information may indicate how a consumer selects purchases based on any of their own body temperature, and/or the ambient temperature as related to their body temperature in a location where a purchase is being made. Additionally, persons or entities that sell beverages could use this information to determine types of selections consumers make based on their body temperature.

In still another example, the image capture device 12 may be positioned near a particular display of goods and may be used to record consumer information relating to consumers that view and/or handle particularized goods from a display. For example, if a retail display has four different styles of shirt in a specific brand, the system 10 may record information relating to which style is handled most from the display. Additionally, the system can acquire any of the characteristic information discussed herein and provide an aggregated output of information such that a person using the information can determine the characteristics of potential consumers that are handling one or more particularized styles. For example, if the display has four styles of shirts—style A, style B, style C, and style D—and system discerns a trend whereby women having a height between five feet and five feet, five inches weighing between approximately 100 to 130 pounds tend to handle style C, this information can be used in subsequent marketing and display efforts.

The systems and methods disclosed herein can further be configured to initiate image capture based on actuating event. An actuating may include, for example, detecting a particular characteristic of a consumer and/or detecting a particular form of payment or range of retail sale. For example, the image capture device may include a web cam on a computer whereby a consumer engaged in computer based purchases has an image captured and information stored as described herein. The present disclosure further contemplates computer based consumers consenting to use of the computer web cam in order to provide consumer demographic information to the system and method of the present invention.

The present invention can be realized in hardware, software, or a combination of hardware and software. Any kind of computing system, or other apparatus adapted for carrying out the methods described herein, is suited to perform the functions described herein.

A typical combination of hardware and software could be a specialized or general purpose computer system having one or more processing elements and a computer program stored on a storage medium that, when loaded and executed, controls the computer system such that it carries out the methods described herein. The present invention can also be embedded in a computer program product that comprises all the features enabling the implementation of the methods described herein, and which, when loaded in a computing system is able to carry out these methods. Storage medium refers to any volatile or non-volatile computer readable storage device such as magnetic storage, semiconductor memory, DVD, Compact Disk or memory stick.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. In addition, unless mention was made above to the contrary, it should be noted that all of the accompanying drawings are not to scale. Significantly, this invention can be embodied in other specific forms without departing from the spirit or essential attributes thereof, and accordingly, reference should be had to the following claims, rather than to the foregoing specification, as indicating the scope of the invention.

Program code may be transmitted to a computer constructed in accordance with the principles of the present invention using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks. It is noted that the computer programs of the present invention can be downloaded via the Internet to a computer, such as network device and/or target host system, having a TCP/IP-based network adapter card for installation in the computer.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. The term “computer-readable storage device” does not encompass a signal propagation media such as a copper cable, optical fiber or wireless transmission media.

It will be appreciated by persons skilled in the art that the present invention is not limited to what has been particularly shown and described herein above. In addition, unless mention was made above to the contrary, it should be noted that all of the accompanying drawings are not to scale. Of note, the system components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Moreover, while certain embodiments or figures described herein may illustrate features not expressly indicated on other figures or embodiments, it is understood that the features and components of the examples disclosed herein are not necessarily exclusive of each other and may be included in a variety of different combinations or configurations without departing from the scope and spirit of the invention. A variety of modifications and variations are possible in light of the above teachings without departing from the scope and spirit of the invention, which is limited only by the following claims.

What is claimed is:

1. A system for compiling consumer information, comprising:
an image database containing a plurality of images of consumers;
an image analysis module configured to identify one or more consumer characteristics from the images in the image database; and
a consumer characteristics database storing the identified consumer characteristics from the image analysis module.

2. The system of claim 1, further comprising an image capture device in communication with the image database.

3. The system of claim 1, wherein the image analysis module includes a computer readable media storing computer-useable instructions.

4. The system of claim 1, wherein the image analysis module includes a central processing unit

5. The system of claim 1, wherein the consumer characteristics include at least one of consumer age, race, weight, and height.

6. The system of claim 1, wherein the consumer characteristics include an article of clothing worn by the consumer.

7. The system of claim 1, wherein the consumer characteristics include at least one of body temperature, amount of time spent in a location, travel path through a location, and time spent in proximity to a particular product.

8. The system of claim 1, wherein the consumer characteristics include the identification of a product considered but not purchased.

9. The system of claim 1, wherein the consumer characteristics database receives and stores information from a point of sale device.

10. A computer-implemented method for collecting consumer information, comprising:
receiving a plurality of images of consumers;
identifying at plurality of consumer characteristics from the images of consumers; and
storing the identified characteristics in a consumer information database on a computer-readable storage device.

11. The method of claim 10, further comprising capturing the plurality of images of consumers from an image capture device.

12. The method of claim 10, wherein the consumer characteristics include an article of clothing worn by the consumer.

13. The method of claim 10, wherein the consumer characteristics include at least one of body temperature, amount of time spent in a location, travel path through a location, and time spent in proximity to a particular product.

14. The method of claim 10, wherein the consumer characteristics include the identification of a product considered but not purchased.

15. The method of claim 10, further comprising receiving information from a point of sale device and storing the received information in the consumer information database.

16. The method of claim 10, further comprising generating a subset of the plurality of images of consumers in response to a query of one or more of the identified characteristics.

17. The method of claim 10, further comprising generating an advertisement based on the information in the customer information database.

18. The method of claim 10, further comprising generating an alert regarding a consumer travel pattern within a location based on the information in the customer information database.

19. The method of claim 10, further comprising generating a list of products that share one or more consumer characteristics based on the information in the customer information database.

20. The method of claim 10, further comprising generating at least one of a survey and coupon for a product not purchased based on the information in the customer information database.

21. A computer program product for capturing and assessing consumer information, the program product comprising:
a computer readable storage device;
first program instructions to receive one or more images of consumers captured from an image capture device;
second program instructions to identify a plurality of consumer characteristics from the images of consumers, wherein the consumer characteristics include an article of clothing worn by the consumer; and
third program instructions to compile the identified plurality of consumer characteristics in a consumer information database.

22. The computer program product of claim 21, further comprising fourth program instructions to generate a subset of the plurality of images of consumers in response to a query of one or more of the identified characteristics.

23. The computer program product of claim 21, further comprising fourth program instructions to receive information from a point of sale device and to store the received information in the consumer information database.

24. The computer program product of claim 21, further comprising fourth program instructions to generate an advertisement based on the information in the customer information database.

25. The computer program product of claim 21, further comprising fourth program instructions to generate an alert regarding a consumer travel pattern within a location based on the information in the customer information database.

26. The computer program product of claim 21, further comprising fourth program instructions to generate a list of products that share one or more consumer characteristics based on the information in the customer information database.

27. The computer program product of claim 21, further comprising fourth program instructions to generate at least one of a survey and coupon for a product not purchased based on the information in the customer information database.
